(19) United States
(12) Patent Application Publication
(10) Pub. No.: US 2005/0278227 A1
(43) Pub. Date: Dec. 15, 2005

(54) Systems and methods of managing price modeling data through closed-loop analytics

(76) Inventors: Niel Esary, Mountain View, CA (US); Simon C. Lee, Castro Valley, CA (US); Rafael A. Gonzalez-Caloni, Redwood Shores, CA (US); Marc H. Brown, Palo Alto, CA (US); Narayanan Vijaykumar, Cupertino, CA (US); Sean M. Murphy, Danville, CA (US)

Correspondence Address: IPSG, P.C., P.O. BOX 700640, SAN JOSE, CA, 95170-0640, US

(21) Appl. No.: 10/857,263

(22) Filed: May 28, 2004

(51) Int. Cl. G06F 17/60

(52) U.S. Cl. 705/26

(57) ABSTRACT

The present invention presents systems and methods for managing price modeling data through closed-loop analytics including a historical database populated with price modeling data; a rule based policy database populated with rules based on historical price modeling data; a transactional database for generating quotes conforming to rules from the rule based policy database; and a service database for transacting quotes generated by the transaction database and providing the transacted quotes to the historical database.

### RELATED APPLICATIONS

This application relates to U.S. patent application Ser. No. ______ filed on May 28, 2004 by ALBANESE, entitled “SYSTEM AND METHOD FOR DISPLAYING PRICE MODELING DATA”. The content of that application is incorporated herein by reference.

### BACKGROUND

At least one primary goal of price modeling is to construct models to capture objective data in order to analyze present price behavior, to create policies responsive to the analysis, and to predict future price behavior. Systems like, for example, SAP™, attempt to manage and control business processes using objective data in order to gain enterprise efficiencies. By manipulating objective data, these systems offer consistent metrics upon which businesses may make informed decisions and policies regarding the viability and direction of their products and services. However, in many cases, the decisions and policies may be difficult to procure as a result of the volume and organization of relevant data and may be difficult to implement as both temporal restraints and approval processes may inhibit rapid deployment of valuable information.

For example, referring to FIG. 1, FIG. 1 is a simplified graphical representation of an enterprise pricing environment. Several example databases (104-120) are illustrated to represent the various sources of working data. These might include, for example, Trade Promotion Management (TPM) 104, Accounts Receivable (AR) 108, Price Master (PM) 112, Inventory 116, and Sales Forecasts 120. The data in those repositories may be utilized on an ad hoc basis by Customer Relationship Management (CRM) 124, and Enterprise Resource Planning (ERP) 128 entities to produce and post sales transactions. The various connections 148 established between the repositories and the entities may supply information such as price lists as well as gather information such as invoices, rebates, freight, and cost information.

The wealth of information contained in the various databases (104-120) however, is not “readable” by executive management teams due in part to accessibility and in part to volume. That is, even though the data in the various repositories may be related through a Relational Database Management System (RDMS), the task of gathering data from disparate sources can be complex or impossible depending on the organization and integration of legacy systems upon which these systems may be created. In one instance, all of the various sources may be linked to a Data Warehouse 132 by various connections 144. Typically, the data from the various sources is aggregated to reduce it to a manageable or human comprehensible size. Thus, price lists may contain average prices over some selected temporal interval. In this manner, the data may be reduced. However, with data reduction, individual transactions may be lost. Thus, CRM 124 and ERP 128 connections to an aggregated data source may not be viable.

Analysts 136, on the other hand, may benefit from the aggregated data from a data warehouse. Thus, an analyst 136 may compare average pricing across several regions within a desired temporal interval and then condense that analysis into a report to an executive committee 140. An executive committee 140 may then, in turn, develop policies directed toward price structuring based on the analysis returned from an analyst 136. Those policies may then be returned to CRM 124 and ERP 128 entities to guide pricing activities via some communication channel 152 as determined by a particular enterprise.

As can be appreciated, a number of complexities may adversely affect this type of management process. First, temporal setbacks exist at every step of the process. For example, a CRM 124 may make a sale. That sale may be entered into a sales database 120, and INV database 116, and an AR database 108. The entry of that data may be automatic where sales occur at a network computer terminal, or may be entered in a weekly batch process. Another example of a temporal setback is the time-lag introduced by batch processing data stored to a data warehouse resulting in weeks-old data that may not be timely for real-time decision support. Still other temporal setbacks may occur at any or all of the transactions illustrated in this figure that may ultimately render results untimely at best and irrelevant at worst. A second drawback to this process is related to delay in that approval processes from executive committees to sales transactions may inhibit sales productivity due to uncertainty in the responsibility structure of the management team. As such, methods of analyzing objective structured data, integrating that analysis into coherent and relevant business policies, and integrating those policies in a timely and efficient manner may be desirable to achieve price modeling efficiency and accuracy.

In view of the foregoing, methods of price modeling closed loop analytics in a hierarchically organized portfolio management system are disclosed.

### SUMMARY

The present invention presents systems and methods for managing price modeling data through closed-loop analytics including a historical database populated with price modeling data; a rule based policy database populated with rules based on historical price modeling data; a transactional database for generating quotes conforming to rules from the rule based policy database; and a service database for transacting quotes generated by the transaction database and providing the transacted quotes to the historical database.

One embodiment of the present invention provides method for managing price modeling data through closed-loop analytics including, populating a historical database with price modeling data; populating a rule based policy database with rules based on historical price modeling data; generating transactional quotes conforming to rules from the rule based policy database; and providing transactional quotes to the historical database.

In still other embodiments of the present invention provides a computer program product in a computer readable media for managing price modeling data through closed-loop analytics, the computer program product including, a historical database populated with price modeling data; a rule based policy database populated with rules based on historical price modeling data; a transaction database for generating quotes conforming to rules from the rule based policy database; and a service database for transacting the quotes generated by the transaction database and providing transacted quotes to the historical database.

### BRIEF DESCRIPTION OF THE DRAWINGS

Embodiments of the invention may best be understood by reference to the following description taken in conjunction with the accompanying drawings in which:

FIG. 1 is a simplified graphical representation of an enterprise pricing environment;

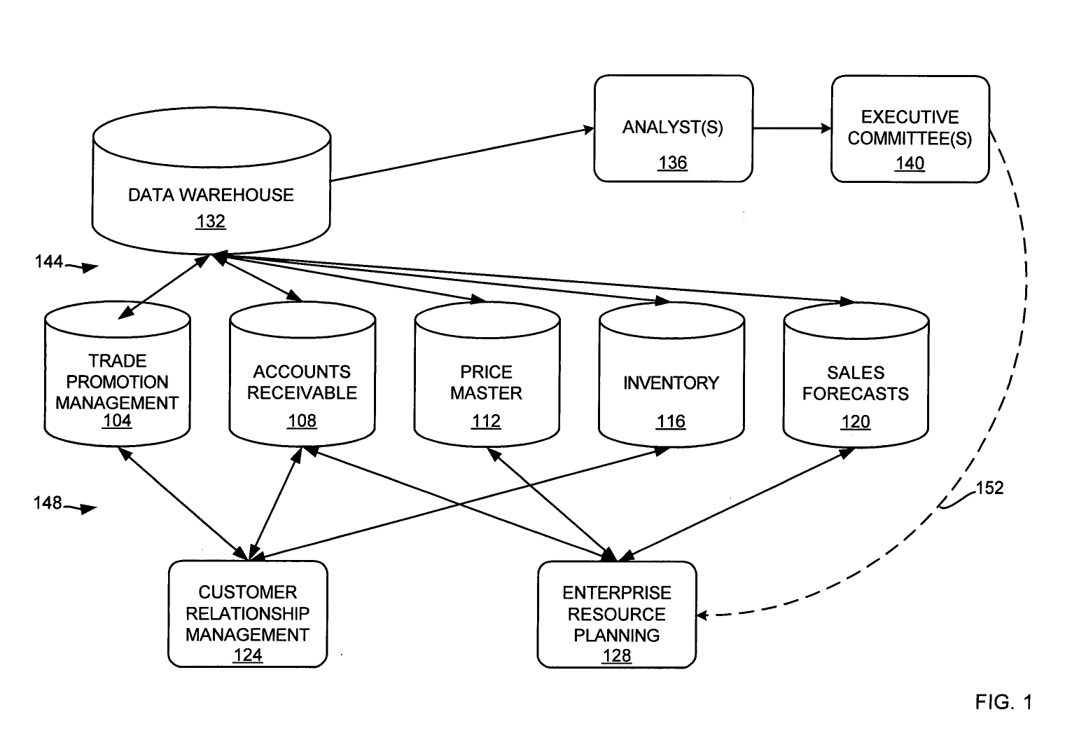

FIG. 2 is a simplified graphical representation of a closed-loop system;

FIG. 3 is a simplified graphical representation of a closed-loop implementation of an embodiment of the present invention;

FIG. 4 is a flow chart of an embodiment of the present invention based on a closed-loop system; and

FIG. 5 is a schematic representation of a portfolio hierarchy in accordance with an embodiment of the present invention.

### DETAILED DESCRIPTION

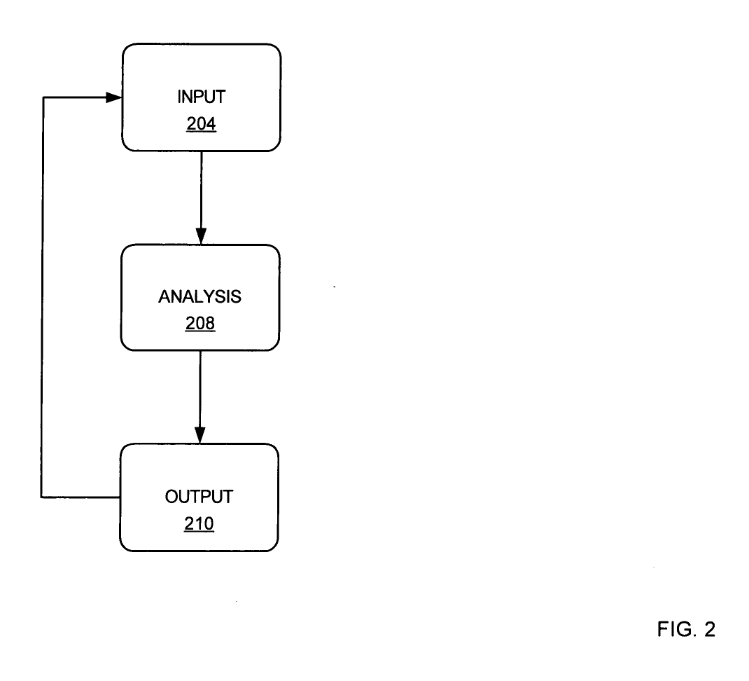

FIG. 2 is a simplified graphical representation of a closed-loop system. As can be appreciated closed-loop systems are common in, for example, the mechanical and electromechanical arts. In general, a closed-loop system is a control system in which the output is continuously modified by feedback from the environment. As illustrated, for example, an input at a step 204 would be a feedback element. Inputs may be any desired indicator or metric that is measurable in some way. For example, an input may be a temperature reading taken from a thermocouple sensor. The input is then analyzed at a step 208. Many types of analysis are available depending on the intended use. A simple comparison against a set value is one example. Another example might include advanced statistical analysis where appropriate. Thus, as can be appreciated, analysis in closed-loop systems may be highly complex.

An output is generated next at a step 210 based on the analysis of step 208. An output may be any operation that is intended to affect a condition of the desired system. In the above thermocouple example, a temperature may be read (e.g., input); compared against a set temperature (analysis); and affected by turning on or off a heating element depending on the comparison (output). Finally, the system loops back to the input and continues until the system, or a user terminates the process.

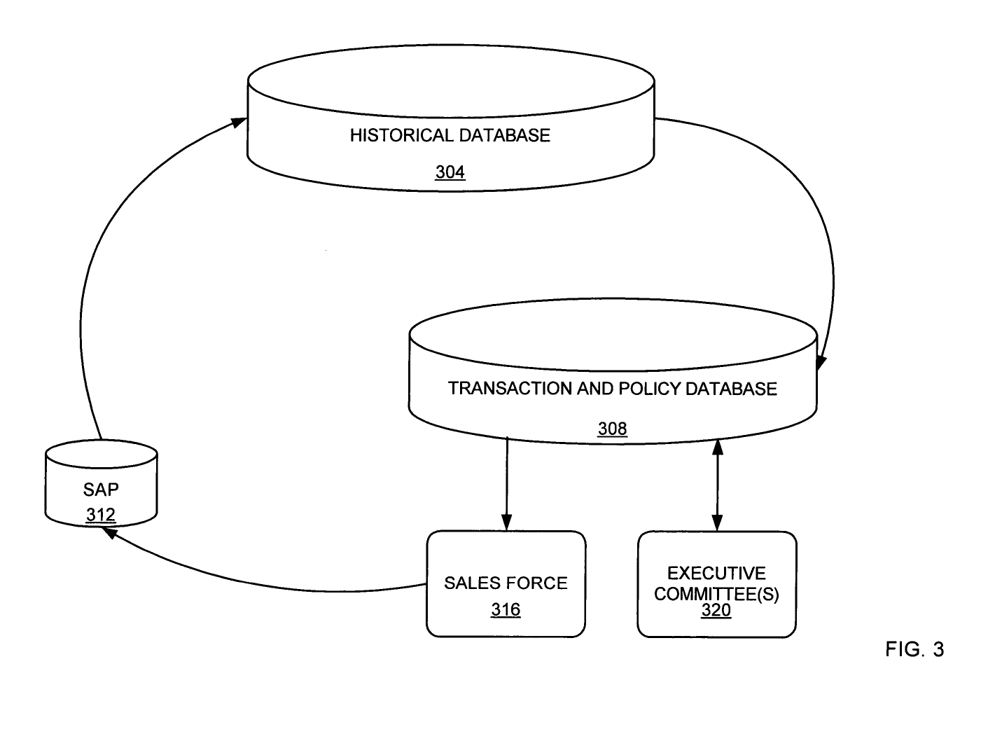

As pertains to the present invention, FIG. 3 is a simplified graphical representation of a closed-loop implementation of an embodiment of the present invention in a price modeling environment. At a first step 304, data is input into a historical database. A historical database, under the present invention may contain any of a number of inputs. In one embodiment of the present invention, a historical database may include sales transactions. In other embodiments of the present invention, a historical database may include waterfall records. A group of associated waterfall records may be defined as a price adjustment continuum. For example, in a transactional sales environment, an invoice price from a transaction may be affected by a rebate such that: invoice price=retail price−rebate. In this example, one waterfall record is a rebate. The rebate represents a price adjustment to the retail price that affects the invoice price. Rebate may also be thought of as a “leakage” in that the profitability of a sale is indirectly proportional to the amount of leakage in a given system. In a price modeling environment, metrics, like rebates for example, that may affect the profitability of a transaction, may be stored at a transaction level in a historical database. Many waterfall records may exist for a transaction like, for example: industry adjustments, sales discretion, shipping charges, shipping allowances, late payment costs, extended terms costs, consignment costs, returns, packaging costs, base material costs, additive costs, processing costs, variable costs, shortfalls, overages, and the like.

The analysis of the data may then automatically generate a transaction and policy database 308. For example, analysis of a selected group of transactions residing in a historical database may generate a policy that requires or suggests a rebate for any sale in a given region. In this example, some kind of logical conclusion or best guess forecast may have determined that a rebate in a given region tends to stimulate more and better sales. This policy is thus guided by historical sales transactions over a desired metric—in this case, sales by region. The policy may then be used to generate logic that will then generate a transaction item. In this example, the logic may have the form:
If customer year-to-year sales growth is greater than X, then rebate=Y %

In this manner, a price list of one or many items reflecting a calculated rebate may be automatically conformed to a given policy and stored for use by a sales force, for example. In some embodiments, policies are derived strictly from historical data. In other embodiments, policies may be generated ad hoc in order to test effects on pricing based hypothetical scenarios. In still other examples, executive committee(s) 320, who implements policies, may manually enter any number of policies relevant to a going concern. In this manner, policies may be both automatically and manually generated and introduced into the system.

After transactions are generated based on policies, the transactional portion of the database may be used to generate sales quotes by a sales force 316 in SAP 312, for example. SAP may then generate a sales invoice which may then, in turn, be used to further populate a historical database 304, which closes the loop. In some embodiments, sales invoices may be constrained to sales quotes generated by a transaction and policy database. That is, as an example, a sales quote formulated by a sales force 316 may require one or several levels of approval based on variance (or some other criteria) from policies stored in a transaction and policy database 308. In other embodiments, sales invoices are not constrained to sales quotes generated by a transaction and policy database.

By applying closed-loop logic to a price modeling environment, pricing advantages may be achieved. In one example, workflow efficiencies may be realized where “successful” sales are tracked and policies supporting activities corresponding to the “successful” sales are implemented. The determination of “successful” in terms of a sale may be defined in any of a number of ways including, for example, increased profitability or volume. In this manner, an enterprise allows real market results to drive sales' policy rather than basing policy solely on theoretical abstractions. In other examples, hypothetical changes to policies may be tested. Thus, for example, a suggested policy requiring a rebate for any sale over $1000.00 may be implemented to test the effect on overall margins without actually modifying existing policies. In that case, a suggested policy change may reveal insight into future sales transactions that result in no net effect on margins, or may reveal insight into areas that require further adjustment to preserve or increase margins.

Another advantage to the system is that policy may flow directly from input data in an efficient manner. Individual spreadsheets and analysis typically used in price modeling may no longer be necessary. Instead, executive committees have access to real-time data that is continually updated to reflect current sales and sales practices. Response to a given policy may be seen or inferred directly from a historical database and implemented directly on a transaction and policy database. Thus, temporal efficiencies are achieved.

In still other examples, a closed-loop system may be used to evaluate individual or grouped transactions as, for example, in a deal making context. That is, a salesperson may generate a quote for a given customer and submit that quote for comparison against a policy formulated transaction in a transaction and policy database. A comparison may reveal some basis upon which a quote may represent a profitable deal. In some embodiments, a deal indicator may be generated. A deal indicator may be a ratio of the quote against a composite index that generates a value between 0 and 1 corresponding to profitability. In this example, a ratio returning unity (i.e. 1) indicates a deal is in conformance with established policy. It may be appreciated that a ratio may be defined in any of a number of manners without departing from the present invention.

In other embodiments, a deal suggestion may be generated. A deal suggestion may provide a range of acceptable (i.e. profitable) pricing based on quote parameters. Thus, a quote having deal specific set parameters like, for example, a fixed shipping price may return a range of allowable rebates or a range of allowable sales discretion that account for a fixed shipping input. In still other embodiments, deal guidance may be provided. Deal guidance provides non-numeric suggestion for a given quote. Thus, deal guidance might, for example, return “acceptable deal,” or “unacceptable deal” in response to a given quote. Policy considerations underlie deal indicators, deal suggestions, and deal guidance. Availability of these comparisons allows a user to select a comparison best fitted to their sales techniques and preferences which may result in sales efficiencies.

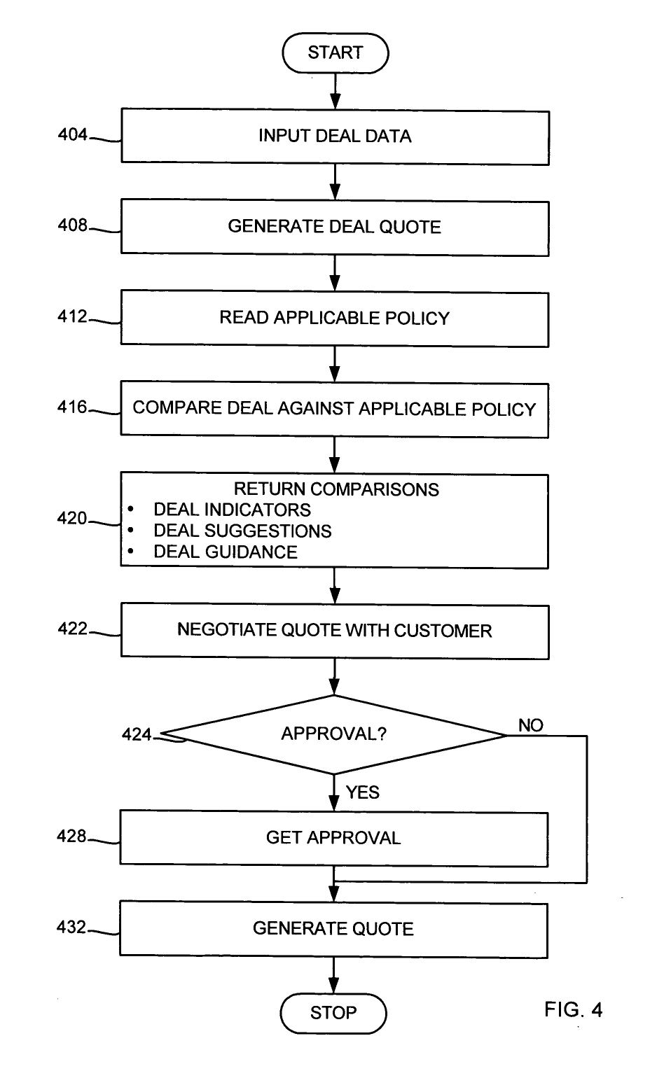

An example embodiment of the present invention using a closed-loop system is next presented. FIG. 4 is a flow chart of an embodiment of the present invention based on a closed-loop system. At a first step, 404 deal data is input into the system. Deal data may include any of a number of inputs like, for example, shipping costs, rebate, discounts, and the like. A deal quote may then be generated at a step 408 calculated from the deal data input at a step 404 and further including any missing field items based on policy considerations. Applicable policy is then read at a step 412. Applicable policy may be automatically selected or user selected by a particular metric. For example, policy may be utilized based on global metrics or may be delimited by region.

After the applicable policy is read at a step 412, a deal quote may then be compared against applicable policy at a step 416. As noted above, a comparison may reveal some basis upon which a quote may represent a profitable deal. Comparisons are then returned for review by a user at a step 420. As noted above, comparisons may include deal indicators, deal suggestions, and deal guidance. An advantage of returning a comparison is that a complex analysis may be reduced to a readily ascertainable form. In this case, a deal indicator may return a ratio; a deal suggestion may return an acceptable range of values; and deal guidance may return a non-numeric suggestion for a given deal. Thus, a deal maker may determine, at a glance, the acceptability based on policy of a given quote.

Once comparisons are returned at a step 420, a quote may be negotiated at a step 422 that may or may not incorporate any or all of those corresponding comparisons. In this manner, a salesperson negotiating a deal may flexibly structure a deal with confidence that the deal may be constrained to comparison parameters resulting in a profitable deal for an enterprise. In one embodiment, entering a negotiated transaction initiates a recalculation of comparisons. Thus, a deal maker may view real-time changes to a deal structure as a deal is being formed. This feature is particularly useful in that final negotiating point parameters may be expanded or contracted as a deal progresses providing a deal maker with an increasingly better defined negotiating position.

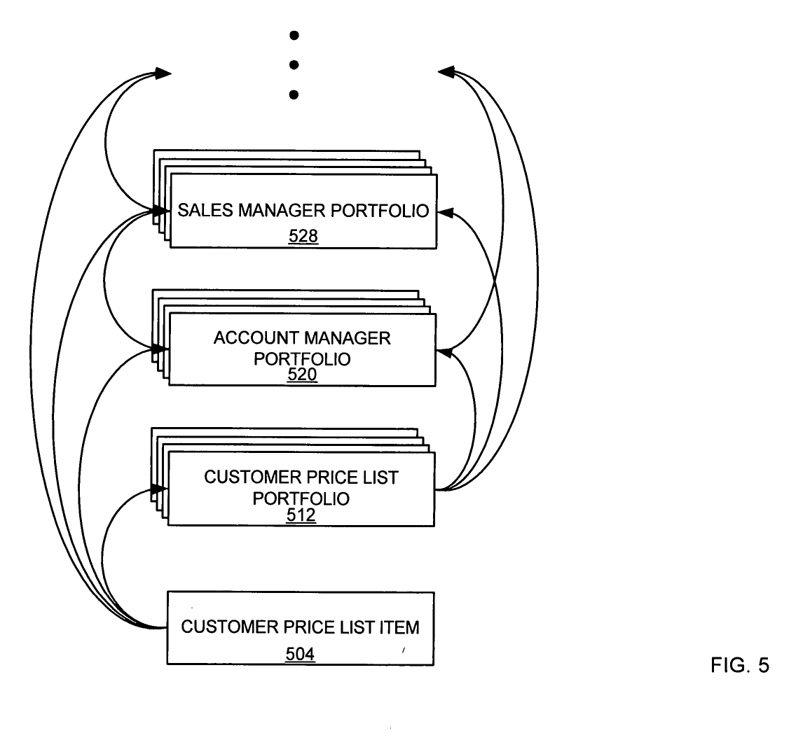

After a quote negotiation is complete at a step 422, the method determines whether approval is needed at a step 424. Approval, in this context, may be coupled with a portfolio manager. A portfolio manager may be utilized in an embodiment of the present invention to efficiently expedite approval of pending deals. Approval may include one or more levels depending on variance from an explicit or implicit policy. That is, for a particular deal that greatly varies from a policy, higher authority must approve of that particular deal. For example, a deal offering a rebate that is within policy limits may not require approval while a similar deal offering a rebate that falls outside of policy limits by, for example, 25% may need a sales manager or higher approval. Approval may be linked upward requiring executive officer approval in some cases. Portfolio management will be discussed in further detail below for FIG. 5.

If approval is needed, then a deal must be approved at a step 428. The method then continues at a step 432 to generate a quote. If approval at a step 428 is not needed, the method continues at a step 432 to generate a quote. As can be appreciated, a quote may then be used to generate an invoice. However, an invoice may or may not match the quote upon which it is based. Rather, an invoice represents an actual sale. It is the data from an actual sale that continues to populate a historical database. The method then ends.

As noted above, a portfolio manager may efficiently expedite approval of pending deals. Enterprises, as a practical reality, have a mix of “good” and “bad” deals—good deals being defined as profitable. Evaluating deals in isolation may not maximize profits at an enterprise level. For example, industries having large fixed costs may accept a number of high volume “bad” deals in order to capture a number of low volume “good” deals resulting in an overall profit. Industries evaluating deals in isolation may not realize this benefit and thus may not be able to survive. Portfolio organization, therefore, assists, for example, sales managers maximize profitability for an enterprise by allowing those managers to view enterprise level effects of a deal or groups of deals.

As seen in FIG. 5, FIG. 5 is a schematic representation of a portfolio hierarchy in accordance with an embodiment of the present invention. A customer price list item 504 exists at the root of the hierarchy as an item. Each item may be configured to require approval on a pending deal, or may be configured to ignore approval on a pending deal. The customer price list item 504 may contain any of a number of descriptive and/or numeric terms such as price, description, availability, etc., for example. In one example, customer price list items 504 may be grouped into a portfolio known as customer price list portfolio 512.

Customer price list portfolios comprise customer price list items grouped according to a desired criteria or criterion. For example, price lists may be organized by cost, by type, by distributor, by region, by function, and by any other selected parameter. In this manner, approval, as an example, for a group of items—items under $1.00 for example—may be required or ignored. By grouping items, approval processes may be retained only for selected key products. In one embodiment, one or more criteria may be utilized to organize customer price list portfolio. It can further be appreciated that many other combinations of groupings for portfolios are possible. Thus, for example, a sales manager portfolio may comprise: customer price list items 504; customer price list portfolios 512; or account manager portfolios 520 as indicated by multiple arrows in FIG. 5. Further, in this example, a customer price list portfolio 512 is a static portfolio. That is, a static portfolio does not change according to a formula or algorithm. Rather, a static portfolio is entered and modified manually. It may be appreciated that most, if not all, portfolios may either be static portfolios or dynamic portfolios.

Customer price list portfolios 512 may then be organized to generate an account manager portfolio 520. Account manager portfolios 520, in this example, comprise customer price list portfolios 512 grouped according to a desired criteria or criterion. Typically, accounts may be organized by named companies or individuals. In addition to organizing accounts by name, accounts may be organized by approval. That is, all approval accounts may be managed singly or in group thus facilitating policy implementation. For example, an account portfolio may be organized such that any account having a 12-month history of on-time transactions no longer needs approval so that approval is ignored. In this way, an on-time account may accrue a benefit of an expedited approval thus making transactions more efficient for both the sales person and the account. Further, in this example, an account manager portfolio is of the type—static portfolio. As noted above, a static portfolio does not automatically change according to a formula or algorithm.

Account portfolios 520 may be further organized to generate sales manager portfolios 528. Sales manager portfolios 528, in this example, comprise account manager portfolios 520 grouped according to a desired criteria or criterion. Typically, sales manager portfolios may be organized by named individuals or groups of individuals. In addition to organizing sales manager portfolios by name, sales manager portfolios may be organized by approval. As noted above, approval based portfolios may be managed singly or in group thus facilitating policy implementation. For example, a sales manager portfolio may be organized such that sales people with seniority no longer need approval for deals under a capped amount. In this way, sales people with more experience benefit from an expedited approval process since presumably more experienced sales people have a deeper understanding of company policies and priorities. In addition, as new policy is generated, approvals may be reinstated as a training measure so that policies may more effectively be incorporated into a workflow. In this example, a sales manager portfolio 528 is of the type—dynamic portfolio. Dynamic portfolios may be generated according to formula or algorithm. For example, a sales manager portfolio may be generated for all sales associates whose total billing exceeds a desired dollar amount. In this way, managers may creatively and efficiently differentiate productive and unproductive sales associates and may further apply varying levels of approval.

As can be appreciated, the examples described herein detail an approval based hierarchy in an embodiment of the present invention. Other hierarchical methods and uses that may be used in combination with approval based hierarchy are contemplated by the present invention. Additionally, approval hierarchy, as described above, may also include varying levels of visibility. That is, at any given level of portfolio, a user may define which entities may access which portfolios.

While this invention has been described in terms of several preferred embodiments, there are alterations, permutations, modifications and various substitute equivalents, which fall within the scope of this invention. For example, the portfolios illustrated in FIG. 5 are illustrative only and may be organized at many levels within an approval hierarchy in numerous ways as noted above. It should also be noted that there are many alternative ways of implementing the methods and systems of the present invention. It is therefore intended that the following appended claims be interpreted as including all such alterations, permutations, modifications, and various substitute equivalents as fall within the true spirit and scope of the present invention.

1. A system for managing price modeling data through closed-loop analytics comprising:
a historical database populated with price modeling data;
a rule based policy database populated with rules based on historical price modeling data;
a transactional database for generating at least one quote conforming to at least one of the rules from the rule based policy database; and
a service database for transacting the at least one quote generated by the transaction database and providing the at least one quote to the historical database.

2. A method for managing price modeling data through closed-loop analytics comprising:
populating a historical database with price modeling data;
populating a rule based policy database with rules based on historical price modeling data;
generating at least one transactional quote conforming to at least one of the rules from the rule based policy database; and
providing the at least one transactional quote to the historical database.

3. A computer program product in a computer readable media for managing price modeling data through closed-loop analytics, the computer program product comprising:
a historical database populated with price modeling data;
a rule based policy database populated with rules based on historical price modeling data;
a transaction database for generating at least one quote conforming to at least one of the rules from the rule based policy database; and
a service database for transacting the at least one quote generated by the transaction database and providing the at least one quote to the historical database.

4. The method of claim 2 wherein the historical database includes a sale transaction.

5. The method of claim 2 wherein the historical database includes a price adjustment continuum.

6. The method of claim 5 wherein the price adjustment continuum includes at least one of an industry adjustment, a sales discretion, a shipping charge, a shipping allowance, a late payment cost, an extended terms cost, a consignment cost, a return cost, a packaging cost, a base material cost, an additive cost, a processing cost, a variable cost, a shortfall cost and an overage cost.

7. The method of claim 2 wherein the at least one transactional quote includes a rebate.

8. The method of claim 7 wherein the rebate is for a sale in a given region.

9. The method of claim 2 wherein the at least one transactional quote require at least one level of approval.

10. The method of claim 2 further comprising generating a deal indicator.

11. The method of claim 10 wherein the deal indicator corresponds to profitability.

12. The method of claim 2 wherein the at least one transactional quote includes a deal suggestion based on at least one quote parameter.
